(19) United States
(12) Patent Application Publication
(10) Pub. No.: US 2016/0236688 A1
(43) Pub. Date: Aug. 18, 2016

(54) METHOD OF CONTROLLING MACHINES WITH CONTINUOUSLY VARIABLE TRANSMISSION

(71) Applicant: Caterpillar Inc., Peoria, IL (US)

(72) Inventors: Barry Mei, Oswego, IL (US); Michael David Mitchell, Aurora, IL (US); Austin Jeremy Scott, Naperville, IL (US)

(73) Assignee: Caterpillar Inc., Peoria, IL (US)

(21) Appl. No.: 15/095,097

(22) Filed: Apr. 10, 2016

(51) Int. Cl. B60W 30/18; B60W 10/101; B60W 10/06

(52) U.S. Cl. CPC B60W 30/18136; B60W 10/06; B60W 10/101; B60W 2300/125; B60W 2520/16; B60W 2530/10; B60W 2720/10

(57) ABSTRACT

A method is provided for controlling a machine having a continuously variable transmission travelling on a ground surface. The method receives signals indicative of an inclination of the ground surface and a payload carried by the machine through an inclination sensor and a payload sensor respectively. The method further includes determining a retarding capability of the machine. The method determines a maximum allowable operating speed for the machine based at least on the inclination of the ground surface, a mass of the machine, the payload carried by the machine and the retarding capability of the machine.

### TECHNICAL FIELD

The present disclosure relates to controlling a machine having a continuously variable transmission. More particularly, the present disclosure relates to controlling a speed of the machine having continuously variable transmission and travelling down a grade.

### BACKGROUND

Transmission systems may be used to couple the output of a prime mover or power source, for example, an internal combustion engine, to a driven element or device such as wheels or a work implement on a work machine. Transmissions are typically part of a powertrain that transmits power that may be in the form of torque and/or rotational speed from the power source such as an engine to the driven element. A continuously variable transmission (CVT) provides an infinite or continuous range of torque-to-speed output ratios with respect to any given input from the prime mover. In other words, the output of the CVT can be increased or decreased across a continuous range in almost infinitesimally small increments.

CVT powertrain machines, and in particular electric drive CVT powertrain, perform retarding by converting machine kinetic energy into electrical energy that is driven back to the engine, causing the engine to overspeed. Electric drive CVT powertrain system is typically sized in such a way that will provide optimal propulsion power. But during a retarding event, it typically lacks the retarding capability of conventional powertrain with a lock-up clutch. Additionally, electric propulsion motors that are directly connected to the ground have an operating speed limit that they must stay below in order to prevent physical damage. For this reason, when retarding down a grade, the machine operating speed must stay below a threshold to prevent run-away machine conditions that can overspeed and damage the motor.

U.S. Pat. No. 8,948,982 discloses a method of managing operation of a machine for preventing damage/wear to movable machine components while travelling down an incline. The method determines a downhill slope value in a direction of travel of machine and establishes a maximum commanded transmission output speed. The method establishes a maximum commanded gear ratio for a variable transmission based on the maximum commanded transmission output speed and a current engine speed. A controller compares the maximum commanded gear ratio to an operator requested gear ratio. A target gear ratio is established based on the minimum of the maximum commanded gear ratio and the operator requested gear ratio.

While travelling downhill a slope, various parameters need to be taken into account to effectively control a machine apart from grade of the slope and the speed of the machine. Hence, there is a requirement for an improved method of controlling a machine having a CVT traveling downhill a grade.

### SUMMARY OF THE DISCLOSURE

In an aspect of the present disclosure, a method to control a machine having a Continuously Variable Transmission (CVT) is disclosed. The method includes receiving an inclination signal indicative of an inclination of the ground surface by an inclination sensor. The method includes receiving a payload signal indicative of a payload carried by the machine by a payload sensor. The method determines a retarding capability of the machine. Thereafter, the method determines a maximum allowable operating speed for the machine based at least on the inclination of the ground surface, a mass of the machine, the payload carried by the machine and the retarding capability of the machine.

### BRIEF DESCRIPTION OF THE DRAWINGS

FIG. 1 shows a side view of an exemplary machine having a Continuously Variable Transmission (CVT) travelling downhill a grade, in accordance with an embodiment of the present disclosure;

FIG. 2 is a block diagram of a control logic for determining a maximum allowable operating speed for the machine having CVT, in accordance with an embodiment of the present disclosure;

FIG. 3 is a flow chart depicting a method of determining the maximum allowable operating speed for the machine having CVT, in accordance with an embodiment of the present disclosure.

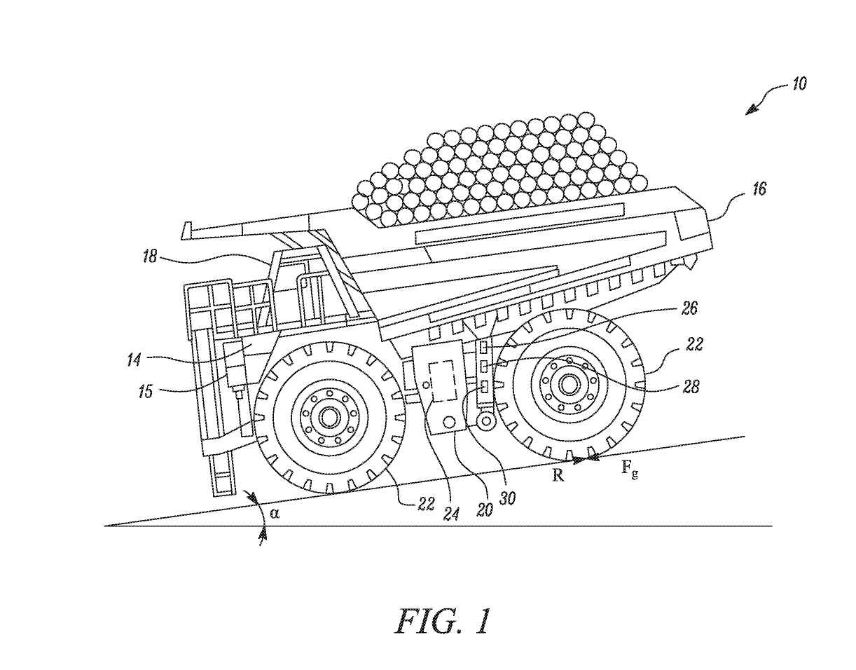

### DETAILED DESCRIPTION

Wherever possible, the same reference numbers will be used throughout the drawings to refer to same or like parts. Referring to FIG. 1, an exemplary machine 10 travelling on a ground surface is illustrated. In the illustrated embodiment, the machine 10 is a load hauling truck. However, the machine 10 may be any other type of machine, for example, an articulated truck, a dozer, an excavator, a loader, and the like. The machine 10 includes a frame 14, and a dump body 16 pivotally mounted to the frame 14. The machine 10 further includes an operator cab 18 mounted on a front end 15 of the frame 14 above an engine enclosure 20. The machine 10 is supported on the ground surface by a pair of traction devices 22, such as wheels. The machine 10 further includes an engine 24 housed within the engine enclosure 20. The engine 24 may be an internal combustion engine, for example, a petrol engine, a diesel engine, or a gas powered engine. The engine 24 is used to provide power to the traction devices 22 through a Continuous Variable Transmission (CVT). Further, the machine 10 may include a number of sensor assemblies associated with the machine 10. The machine may include at least a payload sensor 26, an inclination sensor 28, and a speed sensor 30.

As shown in FIG. 1, the machine 10 is travelling on an incline having an inclination angle α. A set of forces, including gravity creating an acceleration force operating upon the machine 10 having a mass ‘Mₘ’, are also depicted. A gravitational force ‘F_{g}’ tends to pull the machine 10 downhill. A resistive force ‘R’ arising from moving machine parts and components tends to resist the downhill gravitational force ‘F_{g}’. When the two forces are in equilibrium, the machine 10 maintains a steady speed. The machine 10 may also carry a payload having a mass ‘M_{P}’. The payload increases the overall machine mass ‘Mₘ’ and further contributes to the gravitational force ‘F_{g}’. An increase in the gravitational force ‘F_{g}’ leads to a higher speed down the incline. Also, the mass M_{P} of the payload may vary as per the required application.

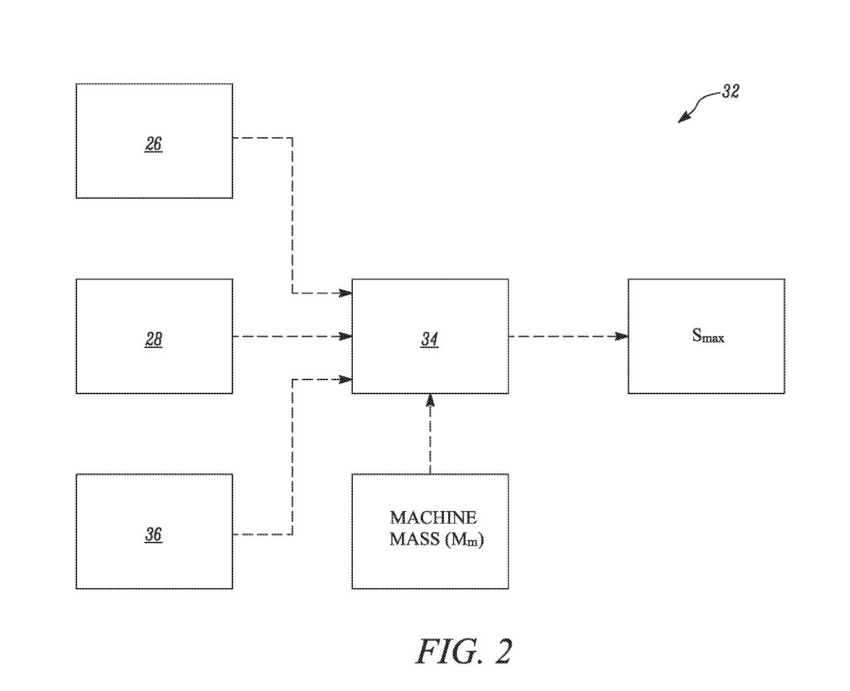

FIG. 2 illustrates a control system 32 for determining a maximum allowable operating speed ‘Sₘₐₓ’ of the machine 10 while travelling down an inclined surface. The control system 32 includes a controller 34. The controller 34 may be a single controller, or alternatively may include more than one controller controlling different functions and/or features of the machine 10. The controller 34 may be an Engine Control Module (ECM) of the machine 10. The controller 34 is in communication with various sensors associated with the machine 10. The controller 34 receives signals from various sensors including at least the payload sensor 26 and the inclination sensor 28.

The payload sensor 26 provides a signal indicative of the payload being carried by the machine 10. The payload sensor 26 may monitor aspects of the machine's suspension or embody a load cell. The payload sensor 26 may also embody an external input representing weight or another device or method known in the art for determining the weight of the payload and the machine 10. The payload sensor 26 may provide an output value of the payload in any of the preferred units. The controller 34 may also have pre-stored information about mass ‘Mₘ’ of the machine 10 when the machine 10 is empty.

The inclination sensor 28 provides an inclination signal to the controller 34. The inclination signal is indicative of a grade/inclination of the ground surface on which the machine 10 is travelling. The inclination sensor 28 may embody an accelerometer, an inclinometer, or another sensor known in the art for determining incline, decline, change in elevation, orientation, or grade of the machine 10. The inclination sensor 28 may also embody a global positioning system, an external input regarding grade at the machine's current position, or an input from an operator of the machine 10. The grade may be measured as a percentage (%) grade of rise divided by run, with 0% grade being a flat incline of zero and a 100% grade being a steep incline of 1 foot rise over 1 foot run (1/1), or a 45 degree incline.

With continuing reference to FIG. 2, the controller 34 is also coupled to a Retarding Capability Module (RCM) 36. The RCM 36 determines the retarding capability of the machine 10 on the basis of various parameters. The parameters may include an engine retarder capability, an implement retarder capability, a machine parasitic load and a powertrain retarding capability.

The engine retarder capability is indicative of availability of an engine retarder. The engine retarder may be an engine brake. The engine brake is a device that retards or slows the engine 24 and the machine 10 by dissipating energy. The engine brake, also known as a compression brake or Jake brake, works by actuating, opening, or controlling the engine's valves. The engine brake may open or actuate an exhaust valve of the engine 24 near top dead center of the compression stroke, thereby releasing compressed air into the exhaust to dissipate energy and slow the machine 10. The engine retarder may be any other type of engine retarding means which may provide retarding power to the engine 24. The RCM 36 may determine whether the engine retarder is installed. If the engine retarder is installed, the RCM 36 checks whether the engine retarder is activated. The RCM 36 may have pre-stored information about power dissipation characteristics of the engine retarder according to various operational conditions of the machine 10. The RCM 36 determines the amount of power which may be dissipated through the engine retarder and stores that as the engine retarder capability.

The implement retarder capability is indicative of power which can be dissipated through an implement system of the machine 10. The implement system may be any type of a work tool attached to the machine 10. For e.g. in case of the machine 10 being an excavator, the work tool may be a bucket. There may also be multiple implements attached to the machine 10. The RCM 36 determines a status of engagement of the implement system. The RCM 36 determines an amount of power being dissipated to the implements of the machine 10. The RCM 36 may have pre-stored information about the work tools installed on the machine 10. The RCM 36 may determine whether the work tools may be supplied with more power. The RCM 36 determines the amount of power which can be dissipated to the implement system and stores the same as the implement retarder capability.

The machine parasitic load is indicative of power utilized by any components or equipment installed in the machine 10 run by power generated by the engine 24. The machine parasitic load may include a Heating, Ventilation and Air Conditioning (HVAC) system for the operator cab 18, a cooling fan for engine 24 etc. The RCM 36 determines the power utilization by the machine parasitic load. The RCM 36 may have pre-stored information about the parasitic loads installed in the machine 10. The RCM 36 determines an amount of power which can be dissipated to the machine parasitic load and stores the same as the machine parasitic load.

The engine retarding capability, the implement retarding capability and the machine parasitic load together represent the maximum power which can be dissipated through various systems of the machine 10 while retardation is required or commanded by the operator of the machine 10.

The powertrain retarding capability is indicative of a maximum power which can be transferred by a powertrain of the machine 10. The powertrain may be an electric drive propulsion/retarding system having a CVT output. The powertrain may include: the engine 24 having an engine shaft; an electric generator, an electric motor having a motor shaft; and the traction devices. These components of the powertrain are operatively coupled to provide power so as to propel the machine 10 during a propulsion phase of operation and to dissipate power so as to retard the machine 10 during a retarding phase of operation.

During the propulsion phase, the engine 24 provides mechanical power to the electric generator via the engine shaft. The electric generator is electrically coupled to the electric motor. The electric generator converts the mechanical power provided by the engine shaft to electrical power and supplies the electrical power to the electric motor. The electric motor supplies mechanical power to the traction devices 22 through the motor shaft. The electrical coupling of the electric generator and the electric motor is controlled so as to provide CVT output. In case of a retarding event, the electric motor takes up mechanical energy from the traction devices through the motor shaft and supplies electrical energy to the electric generator. The electric generator provides mechanical energy to the engine through the engine shaft so as to retard the machine 10.

The powertrain may include an electric resistor grid retarding system (not shown). The electric resistor grid retarding system includes inverters, motors and a braking chopper or Direct Current (DC) link. When operating the machine 10 in the retarding phase, the motors may provide a braking torque sufficient to cause the machine 10 to slow down and/or come to a complete stop. In some embodiments, the motors during retarding may generate alternating current that is converted to DC by the inverters and that flows through the brake chopper through a DC link connection, which provides DC-DC conversion, and into a retarding grid assembly or resistor grid assembly. The retarding grid assembly may include at least a first retarding grid of resistive elements, or resistors and insulators. The resistors may be adapted to receive current from the inverters. The insulators may be adapted to receive heat being radiated from the resistors. The electrical power corresponding to the current generated by the motors may at least partially pass through the first retarding grid and be dissipated as heat.

In some embodiments, additional or excess electrical power may also be dissipated as heat by passing through an optional second retarding grid. The second retarding grid may similarly include a second set of resistors and insulators that are adapted to receive electrical power through the chopper and dissipate the power as heat. The chopper may serve to selectively route a portion of the electrical power through the second retarding grid. In other embodiments, the retarding grid assembly may include a plurality of retarding grids including resistive elements and not be limited to only the first and second retarding grids. Further the powertrain of the machine 10 may also use any other type of retarding means such as a hydraulic retarder etc.

Although the powertrain provides retarding power to the machine 10, there is a limit to the retarding power that can be supplied based on the maximum power which can be transferred by the powertrain. The limit of transferring power may be decided by a maximum operating speed of the electric motor in case of the electric drive CVT powertrain. The powertrain may not be able to retard the machine 10 further than a particular limit. The RCM 36 may have pre-stored information about the powertrain being used in the machine 10. Based on the current operating conditions, the RCM 36 may determine the maximum retarding power which can be provided by the powertrain. The RCM 36 may store the same as the powertrain retarding capability.

After determining the engine retarding capability, the implement retarding capability, the machine parasitic load and the powertrain retarding capability, the RCM 36 determines the machine retarding capability. The RCM 36 calculates an aggregate of the engine retarding capability, the implement retarding capability and the machine parasitic load. The aggregate represents the maximum retarding power which may be dissipated by the machine 10. The retarding power is transferred through the powertrain. The powertrain retarding capability is the maximum power which can be supplied via the powertrain. A minimum of the powertrain retarding capability and the aggregate of the engine retarding capability, the implement retarding capability & the machine parasitic load is determined as the machine retarding capability by the RCM 36.

While travelling downhill, the gravitational force (F_{g}) acts on the machine 10 so as to pull the machine 10 down the incline. With increase in the payload, there may be additional force pulling machine 10 down the incline. The controller 34 calculates the maximum allowable operating speed ‘Sₘₐₓ’ for the machine 10 on the basis of the inclination signal, the payload signal, the mass of empty machine 10, and the machine retarding capability. The maximum allowable operating speed ‘Sₘₐₓ’ is calculated such that the forces acting on the machine 10 are balanced and the machine 10 may not have to face run-away conditions and avoid any physical damage. The controller 34 may use a logical set of formulae stored in memory to calculate the value of the maximum allowable operating speed ‘Sₘₐₓ’. The controller 34 may also have look-up tables stored in memory to determine the maximum allowable operating speed ‘Sₘₐₓ’. The controller 34 may calculate the value of the maximum allowable operating speed ‘Sₘₐₓ’ by referencing the values obtained from various signals to the look-up tables. The controller 34 may use any alternative method to calculate the maximum allowable operating speed ‘Sₘₐₓ’ suitable to the application of present disclosure. The machine 10 should travel slower than the maximum allowable speed ‘Sₘₐₓ’ to avoid losing control and causing run-away events.

In another aspect of the present disclosure, the controller 34 may also receive a signal indicative of speed of the machine 10 from the speed sensor 30. The controller 34 may check whether the speed of the machine 10 is above the maximum allowable operating speed ‘Sₘₐₓ’. The controller 34 may take appropriate control actions to lower the speed of the machine 10 in case the speed is above the maximum allowable operating speed ‘Sₘₐₓ’. The control actions may include applying brakes, lowering a transmission gear ratio and the like.

Although the present disclosure is explained with the CVT being an electric drive CVT, it should be understood that the CVT may be any other type of CVT as well. The CVT may be a hydro-mechanical CVT, a mechanical CVT etc.

### INDUSTRIAL APPLICABILITY

CVT powertrain machines, and in particular electric drive powertrain, perform retarding by converting machine kinetic energy into electrical energy which is driven back to the engine 24. Electric drive powertrain generally have an operating speed limit that the machine 10 must stay below in order to prevent physical damage or run-away conditions. For this reason, when retarding down a grade, operating speed of the machine 10 must stay below a maximum allowable operating speed ‘Sₘₐₓ’. The maximum allowable operating speed ‘Sₘₐₓ’ is a function of various operational parameters such as, but not limited to the payload being carried by the machine 10, the mass ‘Mₘ’ of the empty machine 10, the grade of the ground surface, and the machine retarding capability etc. The payload of the machine 10 varies in different conditions and constitutes an important factor in determining the maximum allowable operating speed ‘Sₘₐₓ’. The payload may vary depending upon the extent of loading of the machine 10. It is vital for achieving higher productivity levels to know precisely the maximum allowable operating speed ‘Sₘₐₓ’ as per the payload. It would allow the machine 10 to travel at highest possible speed without suffering a physical damage or a run-away condition.

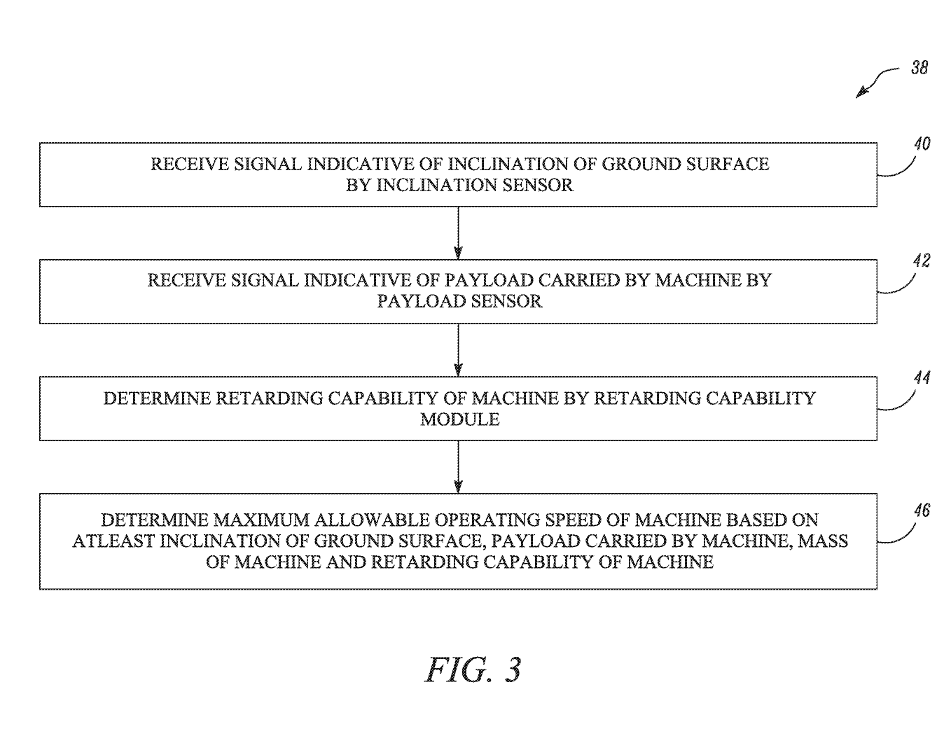

The present disclosure provides a method 38 to determine the maximum allowable operating speed ‘Sₘₐₓ’ taking into account the payload of the machine 10 among various other parameters. FIG. 3 depicts the method 38 with the help of a flow chart. The method 38 at step 40 receives the inclination signal at the controller 34. The inclination signal is indicative of the grade of the ground surface. The inclination signal is provided by the inclination sensor 28. The inclination signal may be provided in form of a grade percentage, inclination angle etc. The method 38 then proceeds to step 42.

The method at step 42 receives the payload signal at the controller 34. The payload signal is indicative of the payload being carried by the machine 10. The controller 34 may have pre-stored information in memory about mass ‘Mₘ’ of machine 10 while the machine 10 is empty. The controller 34 retrieves the value of the mass ‘Mₘ’ of the machine 10. The method 38 then proceeds to step 44.

The method 38 at step 44 receives a signal indicative of the retarding capability of the machine at the controller 34. The retarding capability of the machine 10 is provided by the RCM 36. The RCM 36 determines the retarding capability of the machine 10 on the basis of various parameters. The parameters include the engine retarder capability, the implement retarder capability, the machine parasitic load and the powertrain retarding capability. The RCM 36 individually determines values of these parameters. The RCM 36 calculates a sum of the values of the engine retarding capability, the implement retarding capability and the machine parasitic load. Thereafter, the RCM 36 compares the sum with the powertrain retarding capability. The minimum of the sum and the powertrain retarding capability is determined as the machine retarding capability. The powertrain retarding capability represents the maximum retarding power which can be supplied to the machine 10 by the powertrain. The sum of the engine retarder capability, the implement retarder capability and the machine parasitic load represents the maximum power which can be dissipated via various systems of the machine 10. Hence, the minimum of the sum and the powertrain retarding capability is determined as the machine retarding capability. The method 38 then proceeds to step 46.

The method 38 at step 46, on the basis of the inclination signal, the payload signal, the mass ‘Mₘ’ of the empty machine 10 and the machine retarding capability, determines the maximum allowable operating speed ‘Sₘₐₓ’ for the machine 10. The machine 10 should travel below this speed to avoid any physical damage or run-away conditions.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of controlling a machine having a continuously variable transmission, travelling on a ground surface, the method comprising:
receiving an inclination signal, through an inclination sensor, indicative of an inclination of the ground surface;
receiving a payload signal, through a payload sensor, indicative of a payload carried by the machine;
determining a retarding capability of the machine; and
determining a maximum allowable operating speed for the machine based at least on the inclination of the ground surface, a mass of the machine, the payload carried by the machine and the retarding capability of the machine.

2. The method of claim 1, wherein the retarding capability of the machine is based at least on an engine retarder capability, an implement retarder capability, a powertrain retarder capability and machine parasitic loads.
